(19) United States
(12) Patent Application Publication
(10) Pub. No.: US 2005/0145607 A1
(43) Pub. Date: Jul. 7, 2005

(54) Method for production of 3D laser-induced images with internal structure

(76) Inventors: Igor Troitski, Henderson, NV (US); Karen Cashman, Las Vegas, NV (US)

Correspondence Address: IGOR TROITSKI, 853 ARROWHEAD TRAIL, HENDERSON, NV, 89015, US

(21) Appl. No.: 10/751,325

(22) Filed: Jan. 5, 2004

(51) Int. Cl. B23K 26/00

(52) U.S. Cl. 219/121.69

(57) ABSTRACT

The invention discloses a method for production of laser-induced images with internal structure, so as its internal structure is visible. The method provides the creation of the arrangement of laser-induced damages so that: the outer laser-induced damages do not shade the internal laser-induced damages; all laser-induced damages are located inside 3D image space and reproduced both internal shapes of separate fragments and their shades of gray; all laser-induced damages can be produced by laser-induced breakdown without internal crash of a transparent material. The method can be used for producing both art and tomographic images.

### FIELD OF THE INVENTION

The present invention relates to a method and apparatus for producing an arrangement of laser-induced damages inside a transparent material, and more particularly, for creating an arrangement of laser-induced damages, which reproduce laser-induced images with internal structure. In general, the invention relates to methods, in which laser energy is utilized to generate laser-induced damages based on the breakdown phenomenon.

### BACKGROUND OF THE INVENTION

Present-day laser-induced damage technology gives a chance to produce many laser-induced damages of small sizes and uniform shapes for short time. It gives a chance to reproduce high quality images, having specific optical characteristics, inside transparent materials.

Laser-induced images differ from other images fundamentally. These differences result from the nature of the laser-induced images, which are nothing else but the arrangement of transparent material damages created by laser breakdowns. These damages are transparent material bubbles, which reflect light and depending on how the bubbles reflect the light, the images get different specific characteristics. For its turn, the characteristics of reflected light are formed by two facts: the first is the specific optical characteristics of every individual bubble, and the second is the method, by which the damages are arranged for creating the laser-induced image. U.S. Pat. No. 6,322,958 to Hayashi; U.S. Pat. No. 6,333,486 to Troitski; U.S. Pat. No. 6,392,683 to Hayashi; U.S. Pat. No. 6,399,914 to Troitski; U.S. Pat. No. 6,417,485 to Troitski; U.S. Pat. No. 6,426,480 to Troitski; U.S. Pat. No. 6,490,299 to Raevsky et al. and U.S. Pat. No. 6,509,548 to Troitski disclose methods and apparatus for creation of small laser-induced damages of smoothed shapes.

U.S. Pat. No. 6,322,958 to Hayashi discloses a laser marking method and apparatus focusing the laser beam radiated from the laser source at a converging point inside of a work member to form cracks of specific forms.

U.S. Pat. No. 6,333,486 to Troitski discloses a method and system for production of laser induced damage by generating breakdowns in several separate focused small points inside the etch point area.

U.S. Pat. No. 6,392,683 to Hayashi discloses a laser marking method wherein the split plurality of laser beams are focused onto a very small region of the inner portion of the object to be marked so as to cause degeneration of the very small region of the object to be marked.

U.S. Pat. No. 6,399,914 to Troitski discloses a method for creating laser-induced damages with reduced sharp star structure comprising: production of the special transparent material by introducing special kinds of impurities; and generating laser radiation and focusing it at predetermined points of said material so that the focal spot area contains at least one said impurity and laser energy exceeds the damage threshold of said material with the impurities at the focal area by a negligible amount.

U.S. Pat. No. 6,417,485 to Troitski discloses a method for creating laser-induced damages of smoothed shapes by controlling breakdown process development comprising: generating laser radiation having sufficient energy to induce a plasma condition at a point in said material; and directing said laser radiation at said point to generate said plasma condition and thereafter maintain said condition until sufficient total energy has been delivered to said material so that a resultant damage area of the desired sizes will be created.

U.S. Pat. No. 6,426,480 to Troitski discloses a method for creating small smoothed laser-induced damages of determined sizes with controlling their brightness without variation of their determined sizes.

U.S. Pat. No. 6,490,299 to Raevsky et al. discloses a method and laser system for producing laser-induced damages without star structure by specific laser radiation, which is the serial combination of both generation regimes: a Q-switched mode and a free-running mode.

U.S. Pat. No. 6,509,548 to Troitski discloses a method for creating small laser-induced damages, which is based on generation of the initial electron density in the relatively large volume, creation of the breakdown at a small part of the said volume and control of the energy amount enclosed inside the plasma.

U.S. Pat. No. 6,087,617 to Troitski, et al.; U.S. Pat. No. 6,605,797 to Troitski; U.S. Pat. No. 6,630,644 to Troitski, et al disclose methods and laser-computer graphics systems, which provide the creation of such laser-induced damage arrangements, which on the one hand, reproduce desirable information about given images and on the other hand, the arrangements do not give internal crash of the used transparent material.

U.S. Pat. No. 6,087,617 to Troitski, et al. discloses a computer graphics system for generates an arrangement of the potential etch points. The arrangement is based on the characteristics of the selected optically transparent material so if the number of the potential etch points exceeds a predetermined number, the system carries out an optimization routine that allows the number of the generated etch points to be reduced based on their sizes.

U.S. Pat. No. 6,605,797 to Troitski discloses a laser-computer graphics system for generating an arrangement of laser-induced damages, which enables to produce image with high resolution like a computer graphic image from which it is derived, with little fluctuation in gray shades, and without star point structure.

U.S. Pat. No. 6,630,644 to Troitski, et al. discloses a method for creating arrangement of damages for production of 3D laser-induced damage portrait with the space resolution, which is equal to the appropriate computer 3D model.

U.S. Pat. No. 6,605,797 to Troitski, U.S. Pat. No. 6,664,501 to Troitski and patent application Ser. No. 10/016,013 to Troitski disclose the methods for production of special laser-induced images by creating damages of specific optical characteristics. These specific optical characteristics are created by production of the laser-induced damages of special space shape or by production of these damages inside special transparent materials.

So using laser-induced damages of specific optical characteristics and arranging them by special ways, it is possible to create high quality 2D and 3D laser-induced images having special characteristics. The present invention discloses a method, which expands the list of these characteristics.

The nature of laser-induced damages gives a chance to use one more additional feature of laser-induced images, namely, their “transparency”. Indeed, since laser-induced image is an arrangement of bubbles reflecting light it is possible to arrange the bubbles so as both outside image and its internal structure are visible simultaneously. Using special arrangement of damages it is possible to create great number of laser-induced “enclosure” images, so that a viewer can see the whole aggregate of these internal images simultaneously.

The present invention discloses a method for creating special arrangement of damages for production of “enclosure” images. Such images are very interesting both for art for tomography. Reconstructed tomographic images have internal structure and production of 3D images containing visible internal structure take on special significance for tomography.

### SUMMARY OF THE INVENTION

The principal task of the present invention is to provide a method and apparatus for production of laser-induced images having internal structure so that the internal structure is visible through the outside image.

One or more embodiments of the invention comprise a method for transformation of an image, having internal structure, into arrangement of points, so that the points, being located inside 3D space volume, reproduce visible internal structure of the image.

One or more embodiments of the invention comprise a method for transformation of an image into arrangement of points, so that this arrangement, containing the points of identical brightness, nevertheless reproduces all grade shades of the initial image, and all points of the arrangement can be produced inside transparent material by using breakdown phenomenon without internal crash.

One or more embodiments of the invention comprise a method for transformation of an image into multi-layer arrangement of points so that points of each layer are visible through points of all other layers and all points of the multi-layer arrangement can be produced inside transparent material by using breakdown phenomenon without internal crash.

One or more embodiments of the invention comprise a method for controlling the brightness of laser-induced damages to reproduce visible internal structure of an image.

### DETAILED DESCRIPTION OF THE INVENTION

The invention comprises a method for production of laser-induced images with internal structure, so that its internal structure is visible. Ability to see internal structure of laser-induced image is based on the characteristics of transparent material and can be realized by transformation of corresponding image into special arrangement of laser-induced damages. This invention discloses a method creating such arrangements of the laser-induced damages.

The arrangement of laser-induced damages providing production of laser-induced images with internal structure, so that internal structure is visible, should satisfy the following requirements:
the outer laser-induced damages should not shade the internal laser-induced damages;
all laser-induced damages should be located inside 3D image space so that they reproduce both internal shapes of separate fragments and their shades of gray;
all laser-induced damages should be located inside 3D image space so that internal crash can not arise.

One or more embodiments of the invention comprise a method for transformation of an image with internal structure into arrangement of points, so that the internal laser-induced damages are visible; all these damages reproduce both shapes of internal fragments and their shades of gray; all laser-induced damages are located inside an image so that they can be produced without internal crash of the transparent material.

This method comprises the following steps:

Step 1: transformation of an image into arrangement of points so that the outer laser-induced damages should not shade the internal laser-induced damages.

Step 2: modification of the said arrangement of points so that laser-induced damages created at these points reproduce both the shapes of the separate internal fragments and their shades of gray.

Step 3: transformation of the said arrangement of points, so that laser-induced damages created at the points do not generate internal crash of the transparent material.

Step 4: controlling the brightness of the said laser-induced damages for correction of gray shades internal structure.

Step 5: generating and focusing laser radiation at the points of the transparent material corresponding to the points of the said arrangement so that the marks generated as a result of the interaction of laser radiation with the material are visible.

The first step of this method includes the infill of an internal structure of an image by the points, so that their density of the every internal area corresponds to the gray shade of corresponding area. The point arrangement generated as a result of the infill can contain the points, the distance between which is smaller than the minimal distance d₀. The value d₀ is minimal distance between adjacent laser-induced damages, when internal crash of transparent material does not arise. Therefore after the first step it is necessary to select the points as to move away that points of the said arrangement, the distance between which is smaller than the minimal distance d₀. After this procedure, the point arrangement can be produced inside transparent material by using breakdown phenomenon and, in principle, this arrangement reproduces internal structure of the image, but it is possible that the internal structure cannot be visible clearly, because some outside damages can shade internal damages. Therefore, the next step is the logical removal of outside points, which shade internal points. As a result of the moving away of some points, it is possible that the gray shades of internal areas are changed and therefore it is necessary to make corresponding correction. This correction is made by controlling the brightness of the individual points: if the gray shade of any internal area was changed, as a result of previous procedures, then the brightness of points of this area is modified, so that to compensate for the corresponding modifications.

The brightness of individual laser-induced damage is determined by the size of this damage. The sizes of laser-induced damages are determined by the level of laser energy accumulated by plasma generated by the breakdown. The damage of right size can be created both by controlling the sizes of the focal spot and the pulse duration. The size and the shape of focal spot are determined both by optical system focusing laser radiation and the wavelength of the radiation. So the corresponding modifications of gray shades of internal image structure is produced by controlling pulse energy, pulse duration, temporal shape of the laser pulse, wavelength of the laser radiation or by controlling the optical system. Desirable effect can be reached by controlling one of the factors listed above or combination of these factors.

One or more embodiments of the invention comprise a method for reproduction of internal structure of laser-induced images by generating special multi-surface arrangement of corresponding points. In that case whole internal structure is represented as an aggregate of surfaces enclosed one in another. In principal, these surfaces can have different shapes, but very often it is convenient to use surfaces similar to the outside surface of 3D image. The number of these surfaces is determined by the accuracy of transformation of internal structure with the array of surfaces. However, the distance between adjacent surfaces cannot be smaller than minimal distance d₀, so as the internal crash does not arise.

The points cover these surfaces, so as the laser-induced damages of all internal surfaces are visible; all laser-induced damages, being projected into outside surface, reproduce gray shades of internal fragments; the all laser-induced damages are located at the surfaces inside 3D image space so that internal crash can not arise.

### EXAMPLE

Since the shape of a surfaces is not principal we gives illustration of the creation of right point arrangement for simple surfaces. We assume that surfaces enclosed one in another correspond to the lateral surfaces of a circular cylinder. Then we can imagine cutting the cylinder and unrolling it to obtain a rectangle. As a result, the aggregate of surfaces enclosed one in another is aggregate of rectangles. Let us create the picture of total gray shades corresponding to all internal surfaces by projection of gray shades every internal surface into outer surface. Our task is to transfer this projected picture into arrangement of points, place the points onto different surfaces and place these surfaces inside an image, so that all details of its internal structure are visible.

Let all pixels of the projected picture be numbered as matrix elements, i.e. each element has two indexes, which correspond to X and Y coordinates of the pixels; the coordinates are whole numbers. Let it be necessary to reproduce 17 gray shades: 0; 15; 31; 47; 63; 79; 95; 111; 127; 143; 159; 175; 191; 207; 223; 239; 255. Before transformation of the picture into arrangement of points we should make two preliminary steps. At the beginning, we form 16 areas, so as the first area contains all gray shades except the black one; the second area contains all gray shades except the black one and gray shade corresponding to level 15; the third area contains all gray shades except the black one and gray shades corresponding to levels 15 and 31; the forth contains all gray shades except the black one and gray shades corresponding to levels 15; 31 and 47; and so on. The second step relates to the pixels corresponding to the projected picture. All these pixels are arranged into groups:
group 1 contains pixels with coordinates X=4n, Y=4k;
group 2 contains pixels with coordinates X=4n+2, Y=4k+2;
group 3 contains pixels with coordinates X=4n+2, Y=4k;
group 4 contains pixels with coordinates X=4n, Y=4k+2;
group 5 contains pixels with coordinates X=4n+1, Y=4k+1;
group 6 contains pixels with coordinates X=4n+3, Y=4k+1;
group 7 contains pixels with coordinates X=4n+1, Y=4k+3;
group 8 contains pixels with coordinates X=4n+3, Y=4k+3;
group 9 contains pixels with coordinates X=4n+1, Y=4k;
group 10 contains pixels with coordinates X=4n+3, Y=4k;
group 11 contains pixels with coordinates X=4n+1, Y=4k+2;
group 12 contains pixels with coordinates X=4n+3, Y=4k+2;
group 13 contains pixels with coordinates X=4n, Y=4k+1;
group 14 contains pixels with coordinates X=4n=2, Y=4k+1;
group 15 contains pixels with coordinates X=4n, Y=4k+3;
group 1.6 contains pixels with coordinates X=4n+2, Y=4k+3.

After these steps, transformation of the picture into arrangement of points is produced in the following way: the first area is covered by pixels of the first group; the second area is covered by pixels of the second group; the third area is covered by pixels of the third group and so on. So, the gray shade of 15 is reproduced by the points of the first group; the gray shade of 31 is reproduced by the points of the first and second groups; the gray shade of 47 is reproduced by the points of the first, second and third groups and so on. At the same time, all points can be placed onto 16 surfaces and so that the laser-induced damages of outer surfaces do not shade laser-induced damages of internal surfaces. Moreover, all points reproduce the gray shade picture corresponding to the projected picture.

These sixteen surfaces can be placed inside internal image space and reproduce internal structure of the image. At the same time, all the points can be arranged onto four surfaces and so that distance between them is d₀. In this case, the first surface contains points of the first, second, third and forth groups; the second surface contains points of the fifth, sixth, seventh and eighth groups; the third surface contains points of the ninth, tenth, eleventh and twelfth groups and the forth surfaces contain the residuary groups.

The fact that the point arrangement formed above can be represented by only four surfaces is very important. Practically, it gives a chance to use the point arrangement for production of portraits having seventeen gray shades (including the black one) and to place the portrait onto a surface (or surfaces) of arbitrary shape. Analogically it is possible to create a point arrangement reproducing greater number of gray shades, and this point arrangement can be placed onto not great number of surfaces.

The previous example illustrates a method for transformation of an image into arrangement of points. Although this arrangement consists of the points of identical brightness, nevertheless it reproduces all grade shades of the initial image, and all points of the arrangement can be produced inside transparent material by using breakdown phenomenon without internal crash.

One or more embodiments of the invention comprise a method for reproduction of gray shades of an image by placing the laser-induced damages into several surfaces so that an internal crash does not arise.

One or more embodiments of the invention comprise a method for reproduction of internal structure of tomographic images by production of arrangement of laser-induced damages inside transparent materials.

A tomographic image is an image with internal structure and the general task of this image reproduction is visualization of its internal structure. Very often a tomographic image is an aggregate of 2D reconstructed images. Every 2D reconstructed image is a gray shade picture. Therefore to produce 3D tomographic image it is necessary to transform every 2D reconstructed image into arrangement of points and after that to combine the point arrangements corresponding to separate 2D images into an arrangement describing 3D tomographic image. Formation of whole point arrangement should be done so as outer laser-induced damages do not shade internal damages and so as the internal crash does not arise.

The method comprises the following steps:

Step 1. Transformation of every 2D reconstructed image into multi-layer arrangement of points.

Step 2. Creation of 3D point arrangement corresponding to internal structure of tomographic image by combination of multi-layer point arrangements describing all 2D reconstructed images.

Step 3. Transformation of the 3D point arrangement so as the outer laser-induced damages do not shade the internal laser-induced damages.

Step 4. Modification of the said 3D point arrangement, so as laser-induced damages created at these points reproduce both the shapes of the separate internal fragments and their shades of gray.

Step 5. Transformation of 3D point arrangement, so that laser-induced damages created at the points do not generate internal crash of the transparent material.

Step 6. Controlling the brightness of the said laser-induced damages for correction of gray shades internal structure.

Step 7. Generating and focusing laser radiation at the points of the transparent material corresponding to the points of the said arrangement so that the marks generated as a result of the interaction of laser radiation with the material have the right brightness.

Commentaries. Let reconstructed tomagraphic images reproduce different layers of internal structure along axis Z. Then after the first step, transformation of every 2D reconstructed image gives several layers of points, which are placed onto planes perpendicular to axis Z. The multi-layer point arrangement is formed by the method described above. The number of layers is determined by three factors: the first—reproducing gray shade picture of every reconstructed image; the second—damages corresponding to upper images do not shade damages corresponding to lower images; the third—all layers cover whole internal image space. As a result, the number of layers is greater than the number of images but it is restricted by the condition: the distance between adjacent layers should be larger than d₀. The distance between adjacent damages produced onto every layer is determined by the precision of reconstruction of 2D image but it cannot be smaller than d₀. If a method of the tomographic reconstruction uses a normalization parameter then the distance between adjacent damages of a layer increases with the increase of this parameter. All damages of created point arrangement are visible if you look along the Z, but if you look perpendicularly to the axis Z, some outer points can shade some internal points. Such outer points should be moved away. As a result of this procedure, it is possible that the gray shades of internal areas are changed and therefore it is necessary to make corresponding correction. This correction is made by controlling the brightness of individual points: if the gray shade of any internal area was changed, as a result of previous procedures, then the brightness of points of this area is modified, so that to compensate for corresponding modifications.

1. Method for producing laser-induced images with internal structure inside transparent materials, so that the internal structure is visible, comprising:
transformation of an image into arrangement of points so that the outer laser-induced damages do not shade the internal laser-induced damages;
modification of the said arrangement of points, so that laser-induced damages created at these points reproduce both the shapes of the separate internal fragments and their shades of gray;
transformation of the said arrangement of points, so that laser-induced damages created at the points do not generate internal crash of the transparent material;
controlling the brightness of the said laser-induced damages, so as to reproduce grade shades of internal structure;
generating and focusing laser radiation at the points of the transparent material corresponding to the points of the said arrangement, so that the marks generated as a result of the interaction of laser radiation with the material are visible.

2. The method in accordance with claim 1 including transformation of an image into arrangement of points, so that internal laser-induced damages, produced at these points are visible, comprising:
creation of point arrangement by the infill of the internal structure of an image with the points, so that their density of the each internal area corresponds to the brightness of corresponding area;
removal of those points of the said arrangement, the distance between which is smaller than the minimal distance;
logical removal of outer points, which shade internal points;
correction of the gray shades of the internal areas by controlling the brightness of points belonged to the corresponding areas.

3. The method in accordance with claim 1 including the transformation of an image into arrangement of points, so that this arrangement, containing the points of identical brightness, reproduces all grade shades of the initial image.

4. The method in accordance with claim 1 including the control of the brightness of laser-induced damages by modification of their sizes.

5. The method in accordance with claim 4 including the modification of the damage sizes by controlling the level of laser energy accumulated by plasma generated by the breakdown.

6. The method in accordance with claim 4 including the modification of the damage sizes by controlling the shape and sizes of focal spot and the pulse duration.

7. The method in accordance with claim 4 including the modification of the damage sizes by controlling the temporal shape of laser pulse and its duration.

8. The method in accordance with claim 4 including the modification of the damage sizes by controlling optical system focusing laser radiation.

9. The method in accordance with claim 4 including the modification of the damage sizes by controlling the wavelength of the laser radiation.

10. Method for transformation of an image into multi-surface arrangement of points, so that points of each surface are visible through points of all other surfaces; all points reproduce gray shades of the internal structure of the image; and all points of the said multi-surface arrangement can be produced inside transparent material by using breakdown phenomenon without internal crash.

11. The method in accordance with claim 10 including creation of enclosed surfaces of arbitrary shapes for reproduction of internal structure of an image.

12. The method in accordance with claim 11 including creation of enclosed surfaces, shapes of which are similar to the outer image shape.

13. The method in accordance with claim 10 including reproduction of gray shades of an image by placing the laser-induced damages into several surfaces of arbitrary shapes so that an internal crash does not arise.

14. The method in accordance with claim 10 including creation of a point arrangement for production of portraits having desirable number of gray shades and placing onto a surface (or surfaces) of arbitrary shape.

15. Method for reproducing internal structure of tomographic image by production of arrangement of laser-induced damages inside transparent materials.

16. The method in accordance with claim 15 including creation of 3D arrangement of points reproducing internal structure of a tomographic image by combination of multi-layer arrangement discribing all 2D reconstructed images.

17. The method in accordance with claim 15 including creation of 3D arrangement of points in accordance with normalization parameter of the reconstruction method.
